(19) United States
(12) Patent Application Publication
(10) Pub. No.: US 2020/0359491 A1
(43) Pub. Date: Nov. 12, 2020

(54) PULSED NON-THERMAL ATMOSPHERIC PRESSURE PLASMA PROCESSING SYSTEM

(71) Applicant: Transient Plasma Systems, Inc., Torrance, CA (US)

(72) Inventors: Ryan J. Umstattd, Virginia Beach, VA (US); Jason M. Sanders, Los Angeles, CA (US); Mark Thomas, Torrance, CA (US); Patrick Ford, Torrance, CA (US); Daniel Singleton, Hermosa Beach, CA (US)

(21) Appl. No.: 16/861,658

(22) Filed: Apr. 29, 2020

Related U.S. Application Data
(60) Provisional application No. 62/844,587, filed on May 7, 2019.
(60) Provisional application No. 62/844,574, filed on May 7, 2019.

(51) Int. Cl. H05H 1/48

(52) U.S. Cl. CPC H05H 1/48

(57) ABSTRACT

A system for generating and delivering a low temperature, wide, partially ionized tunable plasma stream is described. The system employs a fast rising, repetitive high voltage pulse generator, flowing gas, and a plasma head to produce the described atmospheric pressure plasma stream and its associated active species. The plasma head may have an exit slit with a relatively wide dimension to produce a relative wide plasma stream. Electrodes may be located proximate the exit slit, for example one in an interior of the plasma head via with gas flows toward the exit slit, and the other exterior to the plasma head and offset from the exit slit. The plasma may include baffle material to enhance a uniformity of flow through and across the exit slit. Plasma heads with having exit slit with different widths may be provided as a kit.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This description relates to a system to produce a wide beam of non-thermal, atmospheric pressure partially ionized plasma with tunable properties using repetitive, fast rising electrical pulses.

### BACKGROUND

Thermal atmospheric-pressure plasmas of large and small size are used for a variety of cleaning, coating, cutting and joining applications, but their high temperatures (many 1000's of degrees Celsius) limit their utility to materials that can withstand those high temperatures.

### SUMMARY

In order to broaden the applicability of the useful chemistries driven by atmospheric plasmas, a system for generating and delivering a wide beam of non-thermal, low temperature (below 50 degrees Celsius) partially ionized plasma with tunable properties has been developed based upon repetitive, fast rising, high voltage electrical pulses and a directed, high speed flow of gas. By using fast rising (greater than 100 V/ns), short duration (<100 ns) pulses, one generates a non-equilibrium plasma in which electrons receive the majority of the delivered pulse energy; the much heavier ion and neutral species in the plasma move too slowly to be directly effected by the fast electrical pulses. Increasing the energy of the electrons opens the door to new chemical pathways in atmospheric pressure plasma treatment, and limiting the energy delivered to the ions and other species reduces the amount of waste heat generated resulting in a much lower temperature output flow.

Briefly and in general terms, the present disclosure is directed to systems and methods to generate a wide beam of near-room temperature plasma using repetitive fast rising high voltage pulses. In the disclosed implementations, the fast rising pulses are transmitted to a plasma head via a coaxial cable. A source (e.g., fan, blower, compressor, reservoir of compressed gas) provides a moving stream of gas. The pulses are applied to the moving stream of gas via electrodes located at the plasma head. The partially ionized plasma that exits the head and its associated active species can be used to perform a variety of surface treatments such as cleaning, activation, disinfection, etching, and coating.

The system may optionally include an adjustable voltage output, an adjustable pulse repetition frequency, and an adjustable flow rate for one or more input gases. The input gas can be a noble gas such as helium or argon for achieving the lowest plasma stream temperatures near room temperature. Compressed air can also be used but with an attendant increase in the plasma stream temperature. The efficacy of the plasma can be tuned or optimized for each application by adjusting the amplitude of the voltage pulse, the repetition rate of the pulses, the velocity or composition of the flowing gas, or a combination thereof. While other atmospheric pressure plasma systems can also be used for cleaning, activation, disinfection, etching, and coating, their ability to optimize their performance for the specific application on a specific substrate is quite limited. For example, most atmospheric pressure plasma systems driven by an alternating voltage signal at a fixed frequency have only 2 or 3 output power settings which change the amount of energy pumped into the plasma. By using repetitive fast rising high voltage pulses, one can smoothly and independently tune key plasma features: increasing the pulse voltage (and the rate of voltage rise) creates different, higher energy radicals and active species, while increasing the pulse repetition rate raises the average number density of these usually short-lived active species.

In some implementations, a dimension (e.g., width) of the electrodes of the plasma head can be selected (e.g., more narrow or more wide) depending on the desired width of the plasma stream. In some implementations, the electrodes may be selectively replaceable in the plasma head, for example allowing an end user to select electrodes of a certain dimension to achieve a desired width of plasma, for instance based on a specific application for which the plasma will be employed. In some implementations, the plasma head may be selectively replaceable, allowing an end user to select a plasma head with electrodes of defined size to achieve a desired width of plasma, for instance based on a specific application for which the plasma will be employed.

The foregoing summary does not encompass the claimed subject matter in its entirety, nor are the illustrated or described implementations and embodiments intended to be limiting. Rather, the illustrated or described implementations and embodiments are provided as mere examples.

Other features of the disclosed implementations or embodiments will become apparent from the following detailed description, taken in conjunction with the accompanying drawings, which illustrate, by way of example, the principles of the disclosed implementations and embodiments.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn, are not necessarily intended to convey any information regarding the actual shape of the particular elements, and have been solely selected for ease of recognition in the drawings.

FIG. 1 is a schematic diagram showing a plasma treatment system, operable to generate low temperature plasma according to at least one illustrated implementation.

FIG. 2 is a circuit diagram showing a drive circuit suitable for inclusion in the fast rising pulse generator of FIG. 1, according to at least one illustrated implementation, the illustrated drive circuit operable to generate the repetitive, high voltage, nanosecond duration electrical pulses used to generate the plasma.

FIG. 3A is a top plan view of a plasma head, according to at least one illustrated implementation.

FIG. 3B is a top plan view of the plasma head of FIG. 3A.

FIG. 3C is a sectional view of the plasma head of FIG. 3A

FIG. 4 is a bar graph showing lap-shear strength evaluation results from EPDM material, with (right) and without (left) plasma treatment.

FIG. 5 is a bar graph showing 180° peel strength evaluation results from silicone material, with and without plasma treatment.

FIG. 6 is a bar graph showing a comparison of water contact angle (WCA) and peel strength over time after silicone surface activation treatment by the subject plasma treatment system.

FIG. 7 is a line graph showing a WCA (Water Contact Angle) of a substrate treated by the subject plasma treatment system.

FIG. 8 is a bar graph showing a surface free energy measured after plasma treatment at various distances.

### DETAILED DESCRIPTION OF THE PREFERRED EMBODIMENTS

In the following description, certain specific details are set forth in order to provide a thorough understanding of various disclosed implementations and embodiments. However, one skilled in the relevant art will recognize that embodiments may be practiced without one or more of these specific details, or with other methods, components, materials, etc. In other instances, well-known structures associated with plasma generation and gas delivery systems have not been shown or described in detail to avoid unnecessarily obscuring descriptions of the implementations and embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one implementation” or “an implementation” or “one embodiment” or “an embodiment” means that a particular feature, structure or characteristic described in connection with the implementation or embodiment is included in at least one implementation or embodiment. Thus, the appearances of the phrases “one implementation” or “an implementation” or “in one embodiment” or “in an embodiment” in various places throughout this specification are not necessarily all referring to the same implementation or embodiment. Furthermore, the particular features, structures, or characteristics may be combined in any suitable manner in one or more implementations or embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the implementations or embodiments.

The present disclosure relates to means of generating a low temperature (less than 50 degrees Celsius) wide plasma stream.

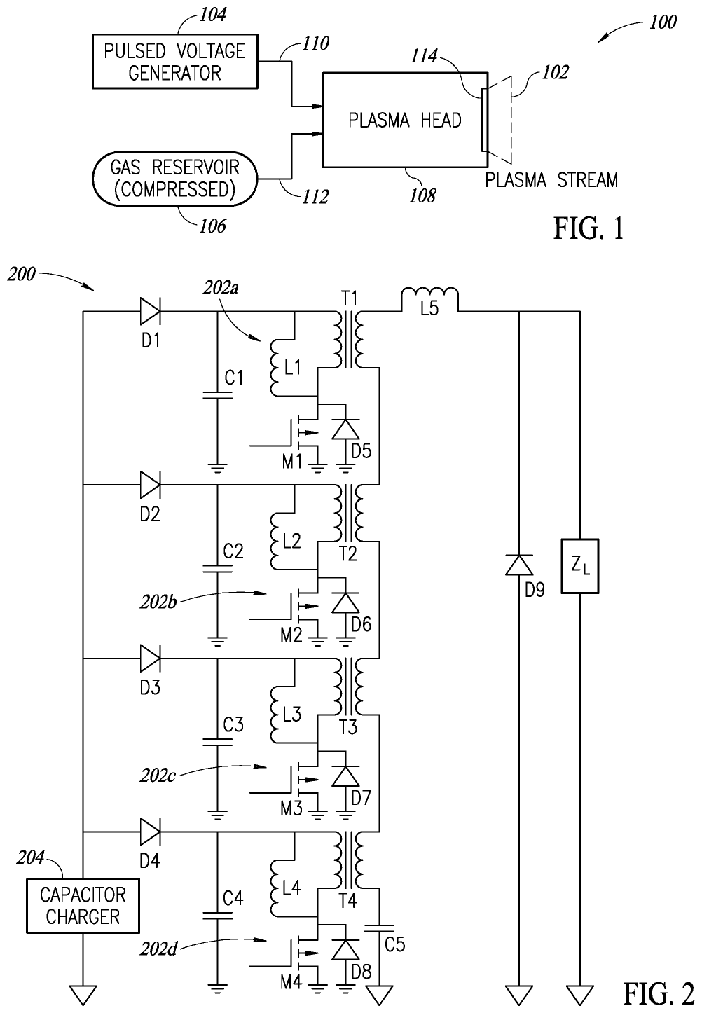

FIG. 1 shows a plasma treatment system 100 according to at least one illustrated implementation, operable to generate a low temperature wide plasma stream 102 by using a repetitive, fast rising, pulsed voltage generator 104, a source of gas 106, and a plasma head 108.

The pulsed voltage generator 104 of plasma treatment system 100 includes a power supply 200 (FIG. 2) operable to generate fast rising high voltage pulses. The voltage pulses are delivered to the plasma head 108, preferably by the coaxial cable 110.

The source of gas 106 of the plasma treatment system 100 may take a variety of forms that provide one a flow or flows of one or more gases to, or at least proximate, the plasma head 108. The source of gas 106 may, for example take the form of one or more reservoirs of compressed gas(es) and one or more compressors operable and fluidly coupled to increase a pressure of gas(es) in the reservoir(s), Alternatively or additionally, the source of gas 106 may include one or more fans, blowers or air movers operable to produce a stream or flow of gas(es). In at least some implementations, the plasma treatment system 100 may include one or more conduits 112 (e.g., hollow tubing) to deliver one or more gases (e.g., compressed gases) to the plasma head 108.

The supplied gas can be a noble gas (such as helium or argon) or compressed air and is provided at flow rates from 0.5 to 50 standard liters per minute (typically 5 SLPM). The flow rate should be high enough to provide a fast-moving gas channel that helps extend the plasma out from the plasma head 108 and into open air, but excessively high flow rates result in turbulent flow that causes the flow to quickly mix with ambient air upon exiting the plasma head 108 thereby quenching the plasma 102. Excessively small flow rates prevent the plasma 102 from extending past the plasma head 108 which limits the ability of the plasma 102 to reach and treat surfaces. The gas may include small amounts (1-5%) of reactive gases (such as oxygen or nitrogen) to encourage desired activation, cleaning, etching or disinfection chemistry in and around the plasma stream 102. Alternatively, the gas may include precursor chemicals that, after being mixed and energized in the plasma stream 102, are subsequently deposited on a substrate to form a desired coating. These precursor chemicals can be destroyed by the plasma 102 if it is too energetic, or they may fail to coat properly if the plasma 102 is not sufficiently energetic. It is important advantage of the described approach to be able to tune the plasma 102 properties in order to achieve the desired coating characteristics.

The plasma head 108 of the plasma treatment system 100 applies the incoming voltage pulses to the stream of moving gas. The electric field created by the voltage pulse is sufficient to ionize a small portion of the gas. The energetic free electrons drive reactions which create excited and reactive species from the surrounding air. The gas then exits the plasma head 108 via a wide exit slit 114 as a combination of charged and neutral particles that includes excited and reactive species.

FIG. 2 shows a drive circuit 200 that is operable to generate a fast rising high voltage pulse to drive a plasma treatment system 100 (FIG. 1), for example the system illustrated in FIG. 1. A series of inductively coupled switching stages 202a, 202b, 202c, 202d (only four shown, collectively 202) discharge capacitors C1, C2, C3, C4 in series to achieve voltage multiplication. The discharge capacitors C1, C2, C3, C4 are charged via a capacitor charger 204. The switching stages 202 each include a respective transformer T, T2, T3, T4, inductor L1, L2, L3, L4, operating switches M1, M2, M3, M4, and are coupled to ground via respective diodes D5, D6, D7, D8. Operating switches M1, M2, M3, M4 causes energy to flow from these capacitors C1, C2, C3, C4 to energize a drift step recovery diode D9, which rapidly interrupts energy stored by a charge circuit inductor L5 to produce a high power, high voltage electrical pulse, which is transmitted via coaxial cable 110 to electrodes of the plasma head 108.

The output of the pulse generator 104 may be of variable amplitude between 1 and 20 kV, but typically operates near 10 kV. The pulse generator 104 generates pulses that are less than 100 nanoseconds in duration, typically between 5 and 20 ns. These pulses repeat at a frequency between single shot up to 100 kHz, but typically in the range of 1 kHz. The average electrical power delivered to the electrodes of the plasma head 108 can range from a few Watts (for narrow plasma heads or mild plasma treatments) to 250 Watts (for wider plasma heads or more intense plasma streams). This approach is in contrast to available AC-driven plasma sources which typically require higher power, generate higher temperatures, and result in more narrow plasma streams with narrower windows of operation for the plasma parameters. By adjusting a combination of the applied voltage, the pulse repetition rate and the gas flow, the plasma stream can achieve various levels of strength with respect to numbers and types of reactive species (e.g., ozone, OH, excited oxygen, excited nitrogen). Thus, this plasma treatment system 100 (FIG. 1) is capable of providing gentle treatments on sensitive substrates as well as intense treatments for more robust substrates. This plasma treatment system 100 is also capable of gently depositing complex precursor chemicals without breaking desired bonds or the plasma can be tuned to dissociate the precursor chemicals so that the nature of the coating is quite different chemically from the precursor material.

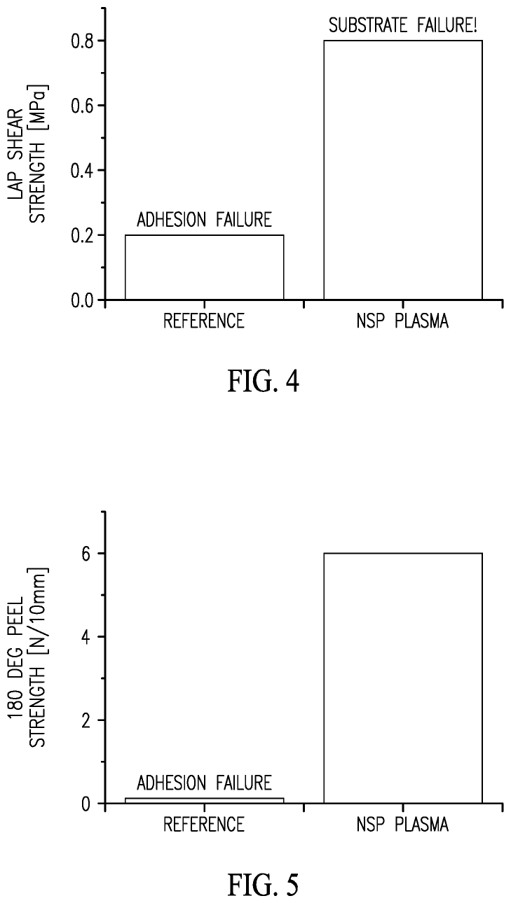

As an example of the ability of the described plasma treatment system to perform desired surface activation on a temperature-sensitive substrate, FIG. 4 provides a relative strength of an adhesive bond applied between two pieces of widely used ethylene propylene diene monomer (EPDM) rubber. When the surface of the EPDM rubber was treated with the described plasma system prior to applying the adhesive, the bond strength increased by a factor of 4 relative to untreated EPDM rubber. Pulling the two pieces of the plasma treated EPDM rubber apart resulted in a tearing of the EPDM rubber material itself rather than any failure of the adhesive or its bond to the EPDM rubber. This result also clearly demonstrates that treatment of the EPDM rubber by the described plasma treatment system did not cause any thermal damage to the surface of the EPDM rubber due to excessive heat.

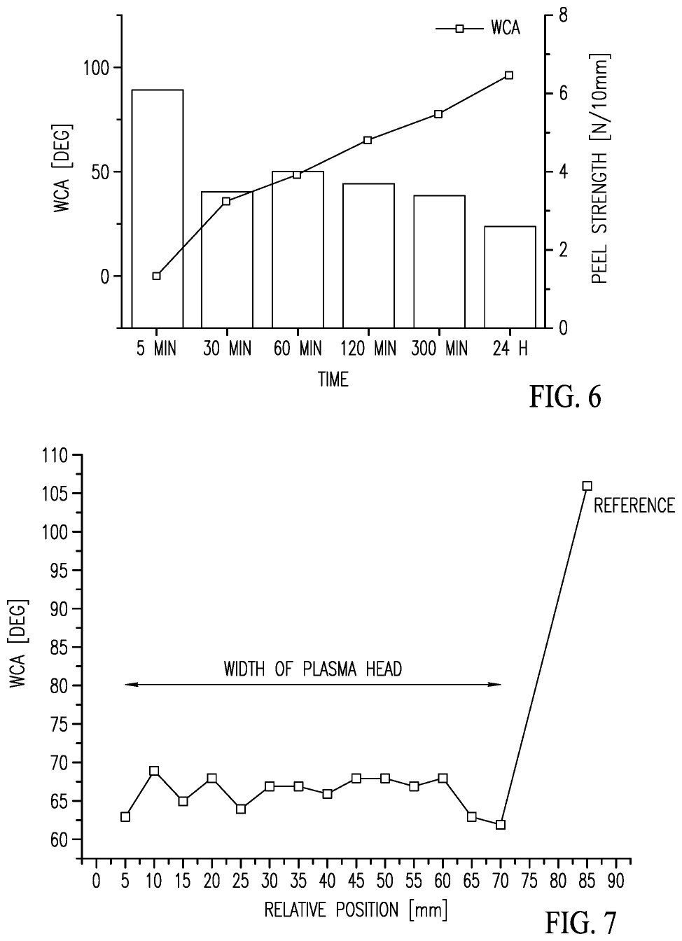

The surface of silicone is notoriously difficult to modify for adhesive applications. Even when silicone is successfully activated, the effect typically decays within minutes or even within seconds. The effectiveness of treatment with the described plasma treatment system for improving the strength of an adhesive bond between two pieces of silicone is shown in FIG. 5, and a time stability of the treatment of silicone with the described plasma treatment system is shown in FIG. 6.

In particular, FIG. 5 shows 180° peel strength evaluation results from silicone material, with and without plasma treatment.

In particular, FIG. 6 shows a comparison of water contact angle (WCA) and peel strength over time after silicone surface activation treatment by the subject plasma treatment system. A time window of five minutes appears sufficient to accomplish a bonding process resulting in higher bonding strength. Even after 60 minutes the surface activation effect was still visible, albeit slightly diminished.

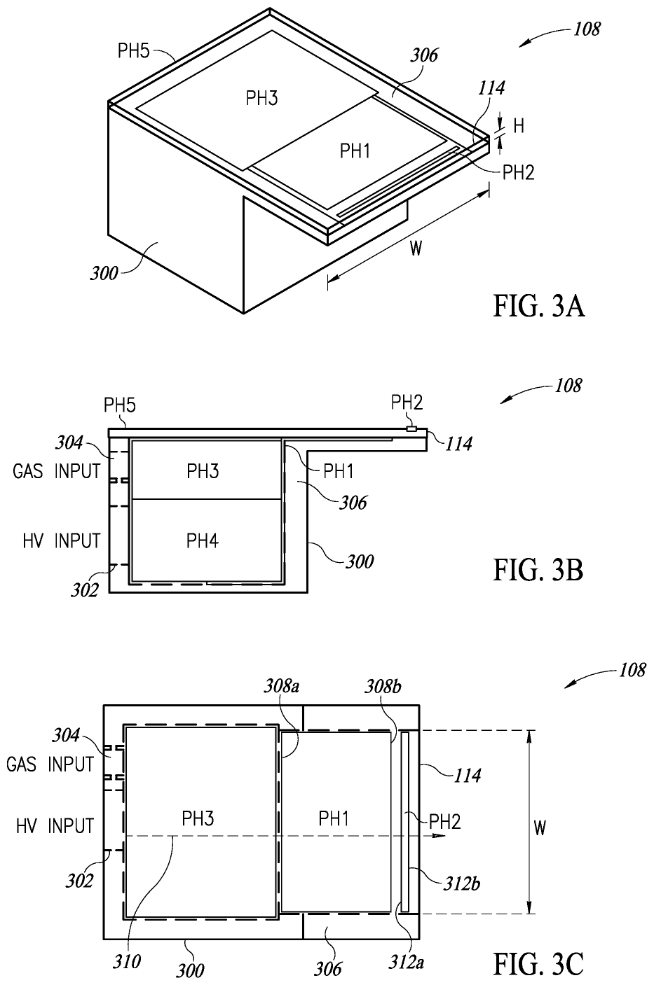

FIGS. 3A, 3B and 3C show the plasma head 108 of the plasma treatment system 100, according to at least one illustrated implementation.

The plasma head 108 includes a housing or body 300, a high voltage (HV) electrode PH1 carried by the housing or body 300, and a ground electrode PH2 carried by the housing or body 300 and spaced from the HV electrode PH1, as described below. The plasma head 108 includes a high voltage input, terminal or node 302 to electrically couple a high voltage to the HV electrode PH1, for example from a pulse generator 104 (FIG. 1) driven by a drive circuit 200 (FIG. 2). A ground input, terminal or node (not shown) electrically couples the ground electrode PH2 to a ground, for example from a pulse generator 104 (FIG. 1) driven by a drive circuit 200 (FIG. 2). The plasma head 108 preferably includes electrical insulation PH 4, to electrically insulate the HV electrode PH1 from the ground electrode PH2, as described below.

As previously discussed, the plasma head 108 includes an exit slit 114, via which gas and/or plasma 102 (FIG. 1) is dispensed or ejected from the plasma head 108. The plasma head 108 include a gas input port 304 (e.g., coupler, quick disconnect coupler, fitting) to fluidly couple a flow of gas to the plasma head 108 from a source of gas 106 (FIG. 1), for example via a hollow tube 112 (FIG. 1) with a complementary fitting at the end thereof. The plasma head 108 includes a fluid flow path in an interior 306 of the housing or body 300 that extends between the gas input port 304 and the exit slit 114, to guide a flow of gas toward the exit slit 114. The fluid flow path may be formed or defined by one or more structures, for example the housing or body 300 of the plasma head 108, a lid PH5 of the plasma head, and/or a baffle (e.g., vanes, screens, baffle material for instance nonwoven fibrous material without an ordered structure) PH3 of the plasma head 108.

The plasma head 108 is where the incoming inputs of a voltage pulse and a gas flow are joined to result in the generation of partially ionized plasma 102 (typically less than 1%) that is then delivered through the exit slit 114. Where the plasma head 108 includes a baffle PH3, the incoming gas stream is mixed in the baffle PH3 in order to provide a more uniform flow through and across the exit slit 114. Non-uniformity in the gas flow results in non-uniformity in the plasma stream 102 (FIG. 1) that exits the plasma head 108.

The exit slit 114 of the plasma head 108 has a width W (FIGS. 3A, 3B) that extends transversely to a flow of gas and/or plasma through and out of the plasma head 108. The exit slit 114 also has a height H (FIG. 3A) that extends transversely to a flow of gas and/or plasma through and out of the plasma head 108 and perpendicular to the width W, the height H being the smaller of the dimensions of the exit slit 114 relative to a dimension of the width W. The dimension of the width W of the exit slit 114 may be selected based on the particular application to which the plasma 102 (FIG. 1) will be used, for example to create a wide plasma stream, a relatively wider plasma stream than the wide plasma stream, or an relatively even wider plasma than the wider plasma stream. In at least some implementations, two or more plasma heads 108 with widths having respective dimensions that are different from one another can be provide in the form of a kit, allowing end users to select the a plasma head 108 having a width dimension that is appropriate for a given plasma task or application.

The dimension of the height H (FIG. 3A) of the exit slit 114 is kept relatively small, and may be constant across various dimensions of the width W, Maintaining a relative small height H may serve two purposes: (1) maintaining a gas flow rate sufficient to create a guiding channel for the plasma to follow, and (2) keeping the electrodes PH1, PH2 close enough to one another to generate the high electric field therebetween used to ionize the gas flow. The incoming voltage pulse is applied across the electrodes PH1, PH2 thereby creating a strong electric field between the two electrodes PH1, PH2. In addition to being separated by the gas flow, the conductive electrodes PH1, PH2 are also separated by the electrically insulating material PH5 that helps discourage arcing through the gas.

The electrically insulating material PH5 provides one of the enclosing walls or acts as a lid PH5 along which the gas and plasma flow. (The lid PH5 is shown as transparent in FIG. 3A to better illustrate the interior of the plasma head 108.) The electrodes PH1, PH2 are arranged such the resulting electric field is predominantly in the direction of the gas flow. The electrodes PH1, PH2 are also arranged such that they do not overlap or approach each other except in the region where a plasma discharge is desired. End points and corners of the electrodes PH1, PH2 may be covered with electrically insulating material in order to prevent localized regions of intense plasma generation due to field enhancement at said end points and corners. It is desirable to place the electrodes PH1, PH2 near the exit (e.g., exit slit 114) of the plasma head 108 so that as much of the plasma stream 102 (FIG. 1) as possible can exit the plasma head 108 before the plasma stream 102 relaxes to a neutral state, but one must also prevent a direct discharge or arc between the two electrodes PH1, PH2 which can happen if the plasma channel directly connects the two electrodes PH1, PH2 and is sufficiently conductive. As best illustrated in FIG. 3B, the HV electrode PH1 has a leading edge 308a (edge farthest upstream in the flow of gas along the flow path 310) and a trailing edge 308b (edge farthest downstream in the flow of gas along the flow path 310). Likewise, the ground electrode PH2 has a leading edge 312a (edge farthest upstream in the flow of gas along the flow path 310) and a trailing edge 312b (edge farthest downstream in the flow of gas along the flow path 310).

The HV electrode PH1 inside the interior 306 of the plasma head 108 is in physical contact with the gas flow and the HV electrode PH1 ends 5-10 mm from the where the plasma stream 102 (FIG. 1) exits (e.g., exit slit 114) the plasma head 108, while the ground electrode PH2 is advantageously located outside the interior 306 of the plasma head 108 and is placed at least 2 mm back from where the plasma exits (e.g., exit slit 114) the plasma head 108 and does not make contact with the gas flow which reduces the likelihood of an arc or direct discharge of the electrical energy from one electrode PH1, PH2 to the other electrode PH1, PH2, thereby reducing the effectiveness of generating plasma 102 (FIG. 1). Since atmospheric air (and similar gases) require an electric field on the order of 30 kV/cm in order to start an electrical discharge, the distance between the electrodes PH1, PH2 is typically a 2-5 millimeters so that an applied voltage of just a few kV is sufficient for ionizing the gas flow. The flowing gas helps create a channel for the propagation of the plasma stream 102 (FIG. 1). The plasma stream 102 (FIG. 1) is rapidly quenched, however, by the surrounding air as charged particles recombine and excited species relax towards lower energy states by giving energy to the surrounding air. In this implementation, the plasma stream 102 (FIG. 1) may extend outward from the end of the plasma head 108 a distance of 1 to 20 mm (typically 5 mm) before being quenched. This extension of the plasma stream 102 (FIG. 1) outside of the plasma head 108 is particularly advantageous, enabling the plasma stream 102 (FIG. 1) to potentially be used for a variety of surfaces or substrate treatments.

As an example of one of the benefits of the described plasma head geometry and described plasma treatment system, FIG. 7 shows a relative uniformity of surface treatment that can be achieved over a wide (70 mm) section of a substrate. In particular, FIG. 7 shows that a WCA (Water Contact Angle) of a treated substrate is relatively homogeneous across the entire 70 mm width of the plasma head. The reference point was on an untreated part of the substrate. This width is an example, and is neither an upper or lower bound to the available geometries of plasma heads.

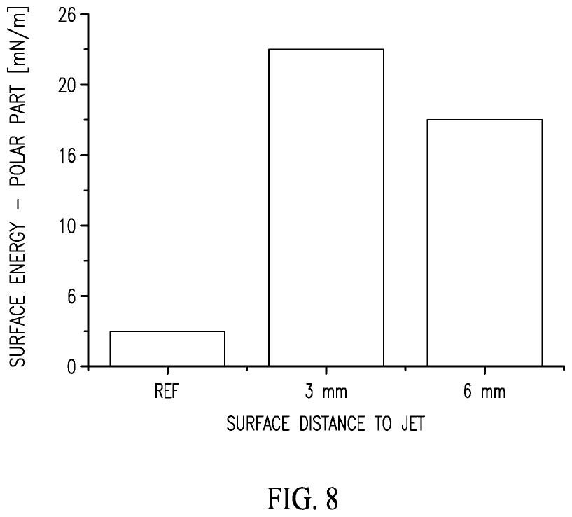

Another benefit of this plasma head geometry is the ability to effectively treat over a range of plasma head-to-substrate distances. While some atmospheric-pressure plasma treatment systems are only effective up to distances of 2-4 mm, FIG. 8 shows that the described plasma treatment system is quite effective at significantly raising a surface energy of a substrate at distances up to 6 mm. This feature enables the effective surface treatment of non-uniform or rough substrates over a range of distances that can be maintained easily, whether performed with a hand-held or robotically controlled plasma head.

Various embodiments of the devices and/or processes via the use of block diagrams, schematics, and examples have been set forth herein. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

When logic is implemented as software and stored in memory, one skilled in the art will appreciate that logic or information, can be stored on any computer readable medium for use by or in connection with any computer and/or processor related system or method. In the context of this document, a memory is a computer readable medium that is an electronic, magnetic, optical, or other another physical device or means that contains or stores a computer and/or processor program. Logic and/or the information can be embodied in any computer readable medium for use by or in connection with an instruction execution system, apparatus, or device, such as a computer-based system, processor-containing system, or other system that can fetch the instructions from the instruction execution system, apparatus, or device and execute the instructions associated with logic and/or information. In the context of this specification, a “computer readable medium” can be any means that can store, communicate, propagate, or transport the program associated with logic and/or information for use by or in connection with the instruction execution system, apparatus, and/or device. The computer readable medium can be, for example, but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette (magnetic, compact flash card, secure digital, or the like), a random access memory (RAM), a read-only memory (ROM), an erasable programmable read-only memory (EPROM, EEPROM, or Flash memory), an optical fiber, and a portable compact disc read-only memory (CDROM). Note that the computer-readable medium, could even be paper or another suitable medium upon which the program associated with logic and/or information is printed, as the program can be electronically captured, via for instance optical scanning of the paper or other medium, then compiled, interpreted or otherwise processed in a suitable manner if necessary, and then stored in memory.

In addition, those skilled in the art will appreciate that certain mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. All of the above U.S. patents, U.S. patent application publications, U.S. patent applications, foreign patents, foreign patent applications and non-patent publications referred to in this specification and/or listed in the Application Data Sheet, including but not limited to commonly owned: U.S. Pat. No. 10,072,629; U.S. patent application Ser. No. 16/254,140; U.S. patent application Ser. No. 16/254,146; U.S. patent application Ser. No. 12/703,078; U.S. provisional patent application 62/699,475; U.S. provisional patent application 62/844,587, entitled “PULSED NON-THERMAL ATMOSPHERIC PRESSURE PLASMA PROCESSING SYSTEM” and filed on May 7, 2019 (Attorney Docket No. 910235.408P1) and U.S. provisional patent application 62/844,574, entitled “A METHOD FOR APPLYING A PLASMA RINSE TO FINGERNAILS” and filed on May 7, 2019 (Attorney Docket No. 910235.407P1) are each incorporated herein by reference, in their entirety.

The various embodiments and examples described above are provided by way of illustration only and should not be construed to limit the claimed invention, nor the scope of the various embodiments and examples. Those skilled in the art will readily recognize various modifications and changes that may be made to the claimed invention without following the example embodiments and applications illustrated and described herein, and without departing from the true spirit and scope of the claimed invention, which is set forth in the following claims.

1. A system to produce and deliver a wide beam of non-thermal, atmospheric pressure, partially ionized tunable plasma comprising:
at least one plasma head, the at least one plasma head including an exit slit and two electrodes spaced apart from one another at least proximate the exit slit and which apply a high voltage pulse across a flowing gas; and
at least one fast rising repetitive pulse generator coupled to drive the electrodes of at least one plasma head.

2. The system of claim 1 wherein the plasma head includes a gas input to receive a flow of gas, and a flow path within the plasma head that extends between the gas input and the exit slit.

3. The system of claim 2, further comprising a gas supply fluidly coupleable to the gas input and which is variably operable both in composition and flow rate in order to achieve a set of desired plasma characteristics.

4. The system of claim 2 wherein a first electrode is positioned in an interior of the plasma head, and a second electrode is positioned externally from the interior of the plasma head.

5. The system of claim 4 wherein the first electrode is positioned spaced relatively upstream of the second electrode with respect to a direction of flow long the flow path.

6. The system of claim 1 wherein the plasma head further includes a baffle positioned along the flow path between the gas input and the exit slit.

7. The system of claim 1 wherein the baffle comprises a baffle material without an ordered structure.

8. The system of claim 1 wherein a first electrode is a high voltage electrode positioned in an interior of the plasma head, and a second electrode is ground electrode positioned externally from the interior of the plasma head.

9. The system of claim 1, wherein the fast rising repetitive pulse generator is operable to generate high voltage pulses with rises at a rate greater than 100 V/ns, with a duration less than 100 nanoseconds, and repeatable at a user-selected frequency greater than 100 Hz.

10. A plasma head to produce in a wide beam of non-thermal, atmospheric pressure, partially ionized tunable plasma, the plasma head comprising:
a body having an interior and an exterior, a flow path, and an exit slit, the exit slit having a width and a height, the width greater than the height;
a first electrode carried by the body at least proximate the exit slit;
a second electrode carried by the body at least proximate the exit slit and spaced from the first electrode;
at least one terminal to electrical couple at least one of the first and the second electrodes a pulse generator to receive high voltage pulses;
at least one gas input port to fluidly couple the flow path to a source of gas;
a baffle in the flow path between the at least one gas input port and the exit slit to mix an input gas flow.

11. The plasma head of claim 10, wherein a first one of the two conductive electrodes is in the interior of the body and in physical contact with the gas flow.

12. The plasma head of claim 11 wherein the second one of the two conductive electrodes is exterior to the interior of the body, and is has a leading edge spaced 2 mm to 5 mm downstream from a trailing edge of the first one of the two conductive electrodes which is in the interior of the body.

13. The plasma head of claim 12 wherein the second one of the two conductive electrodes which is exterior to the interior of the body has a trailing edge that is spaced at least 2 mm upstream from exit slit of the plasma head.

14. The plasma head of claim 10 wherein a first one of the two conductive electrodes is positioned spaced relatively upstream of a second one of the two conductive electrodes with respect to a direction of gas flow long the flow path.

15. The plasma head of claim 14 wherein the first one of the two conductive electrodes is positioned from 5 mm to 10 mm upstream from the exit slit with respect to the gas flow along the flow path.

16. The plasma head of claim 10 wherein a first electrode is a high voltage electrode positioned in an interior of the plasma head, and a second electrode is ground electrode positioned externally from the interior of the plasma head.

17. The plasma head of claim 10 wherein the baffle comprises a baffle material without an ordered structure.

18. The plasma head of claim 10, further comprising an electrically insulating material that physically separates one of the two conductive electrodes from the gas flow along the gas flow path.
